(19) United States
(12) Patent Application Publication
(10) Pub. No.: US 2015/0165667 A1
(43) Pub. Date: Jun. 18, 2015

(54) ELECTROSPINNING SLOT DIE DESIGN AND APPLICATION

(71) Applicant: Zeus Industrial Products, Inc., Orangeburg, SC (US)

(72) Inventors: Robert L. Ballard, Orangeburg, SC (US); Bruce L. Anneaux, Lexington, SC (US); Shannon Giovannini, Columbia, SC (US); Joshua L. Manasco, West Columbia, SC (US); Zahidul Wahab, Orangeburg, SC (US)

(21) Appl. No.: 14/575,113

(22) Filed: Dec. 18, 2014

Related U.S. Application Data
(60) Provisional application No. 61/917,511, filed on Dec. 18, 2013.
(60) Provisional application No. 61/950,252, filed on Mar. 10, 2014.

(51) Int. Cl. B29C 47/00

(52) U.S. Cl. CPC B29C 47/0076; B29K 2101/00

(57) ABSTRACT

An improved process for forming a polymer mat is described. The process of electrospinning polymer fibers includes providing an apparatus having a charge source, a target a distance from the charged source and a slot die having a spinning edge with a slit. The spinning edge has a radius of curvature between 5 cm and 100 cm. The method further includes providing a polymeric preparation (solution, dispersion, suspension, or melt) to the slot die and applying an electric field to a part or the whole apparatus or polymeric preparation. When the electric field is applied, a plurality of Taylor cones are produced with jets that stretch the polymeric preparation into a fibrous structure that can be collected on a target surface.

### CROSS-REFERENCE TO RELATED APPLICATIONS

This application claims the benefit of U.S. Provisional Application No. 61/917,511, filed Dec. 18, 2013, and U.S. Provisional Application No. 61/950,252, filed Mar. 10, 2014.

### Incorporation by Reference

The entire disclosures of U.S. Provisional Application No. 61/917,511, filed Dec. 18, 2013, and U.S. Provisional Application No. 61/950,252, filed Mar. 10, 2014, are incorporated herein by reference.

### FIELD OF DISCLOSURE

The present disclosure generally relates to a slot die for electrospinning polymeric fiber.

### BACKGROUND

The process of electrospinning is well known in the art as represented in U.S. Pat. Nos. 2,158,416; 4,043,331; 4,044,404; 4,143,196; 4,287,139; 4,323,525; 4,432,916; 4,689,186; 6,641,773; and 8,178,030, each of which is incorporated herein by this reference. Electrostatic spinning, also referred to in the art as electro spinning or espinning, involves a charged polymer moving towards a charged or grounded surface. The fibers produced by electrospinning have submicron or “nano” diameters and their resultant fabrics have been found to be useful in the filtration, medical, and textile areas. These fibers with their dense packed yet porous structure can effectively be used for gas or fluid separation or absorption.

Electrospun polymeric fiber can be derived from a melt, solution, or dispersion. For example, the melt, solution, or dispersion can be discharged through a small charged orifice, such as a needle, towards a target wherein the needle and target have opposing electrical charges. The target (also sometimes referred to as the collector) includes a collection surface, which may be of a variety of materials and shapes, as will be understood by those skilled in the art. When an electric potential is placed on the melt, solution, or dispersion, and as the charge attempts to move to ground (i.e., the target or collector), one or more jets can be produced from which the fiber is drawn. A needle or small orifice typically produces a single jet, which can produce fiber at a rate of about 0.1 g/hr. Throughput of this type of electrospinning apparatus is usually very low. This process produces long fibers with a relatively narrow range of fiber diameters in the micron to submicron range. When fibers are allowed to accumulate on the collection surface, they produce a nonwoven fabric, also referred as a mat. Such apparatus for electrospinning from a single orifice and producing a single jet are represented by U.S. Pat. No. 8,178,030B2, and U.S. Pub. Nos. 2003/0215624A1, 2009/0032475A1, 2010/0233812A1, and 2011/0082565A1, each of which is incorporated herein by this reference.

Additional orifices can be added and banks of orifices in two-dimensional blocks or single lines may be used. Such apparatuses for producing multiple jets from multiple orifices are represented by U.S. Pat. No. 7,980,838B2; U.S. Pub. Nos. 2007/022563A1; 2008/0241297A1; and 2008/0277836A1, and European Patents EP 1,967,617A1; 1,975,284A2; and 1,992,721, each of which is incorporated herein by this reference. However, one issue of the multiple orifices producing multiple jets is the repulsion between the multiple jets due to the jets having the same or similar electric charge. The repulsion between the jets can cause bending, as well as possible suppression of the jets; thus, jet stability suffers, resulting in one or more of erratic spinning, less uniform deposition of fibers, a wider range of fiber diameters, and fiber breakage.

One or more jets can also be generated from the same orifice by increasing the electrical potential between the charged source (dispersion, solution, or melt) and the collector. The increase in electric potential increases the throughput proportionately, but at the expense of jet stability since the jets are mutually repulsive.

Another technique in the art is to electrospin from a charged free surface. A charge is placed on the dispersion, solution, or melt and free surface electrospinning occurs from a wire, a cylinder turning in a trough, or the like. At points of perturbation on the surface of the dispersion, solution, or melt, jets may form. An advantage of this approach is that multiple stable jets may be formed so that higher, more uniform throughputs may be obtained.

For free surface electrospinning, the ejection volumes are dependent upon, for example, but not limited to: 1) the viscosity of the dispersion, solution, or melt; 2) the distance from the dispersion source to the collection surface; 3) solvent properties; 4) the rate of loading or covering of the wire or cylinder of the spinning apparatus; or 5) the voltage. These factors also affect the thickness of the mat and the desired fiber diameters, so optimization of these parameters is required. The equipment for free surface electrospinning from a trough or wire process has been commercially developed for solution and dispersion electrospinning and lab, pilot, and commercial sized units are available. Lab units have also been developed for melt electrospinning Apparatuses for electrospinning from free surfaces are known in the art and are represented by: US Pat. Nos. 7,967,588B2 and 8,231,822B2; U.S. Pub. Nos. 2009/014547A1 and 2010/0272847A1; European Patents EP 1,673,493B1 and 2,059,630B1; and International Patent Publications WO 2008/028428A1 and 2009/049566A2, each of which is incorporated herein by this reference.

Further exemplary discussion of materials and methods as disclosed herein is provided in U.S. provisional patent application No. 61/917,511, filed Dec. 18, 2013 and U.S. provisional patent application No. 61/950,252, filed Mar. 10, 2014, which are both incorporated herein by reference in their entireties.

While advancements in producing multiple stable jets from free surface electrospinning have been made, there are still several shortcomings, such as uniformity of the deposited fiber and the characteristics of the fiber and the derived nonwoven fabrics. Furthermore, being able to control a variety of compositions and allowing for different polymeric preparations (e.g., that may not be electrospun on other electrospinning apparatuses) would be very desirable attributes. Thus, a need exists for processes and apparatuses that address various deficiencies or that would create additional benefits, including the deficiencies and benefits described above.

### SUMMARY

The present disclosure generally relates to processes and apparatuses for high-throughput electrospinning of nonwoven materials. One aspect of the present disclosure involves a process of generating a substantially uniform electric field along and about the slit of a slot die, and “electrospinning” a polymeric solution, dispersion, suspension, and/or melt (collectively and individually referred to herein as “polymeric preparation”) from the slit through the substantially uniform field to a collector. Another aspect involves purposeful generating of a non-uniform electric field along and about the slot die slit. According to another aspect of the present disclosure, an apparatus is provided, comprising a slot die having a spinning edge with a slit. The slot die can be shaped to generate, according to some embodiments, a uniform, and according to some embodiments a purposefully non-uniform, electric field along and about the spinning edge when voltage is applied to the polymeric preparation and/or slot die. According to one embodiment, the spinning edge can be curved, defining at least one arc. The curved spinning edge can have a radius of curvature of at least 1 cm, and in one embodiment, between 5 and 100 cm inclusive. According to one embodiment, the curved spinning edge comprises a slit having a width (e.g., 90° perpendicular to the direction of the slit) between 0.01 and 10 mm, inclusive. The apparatus can further comprise one or more of a reservoir for holding the polymeric preparation, a collector installed a distance away from the slot die, a power source to apply a voltage difference between the slot die and the collector, and a delivery mechanism or pathway to supply the polymeric preparation to the slot die.

Additional features, advantages, and embodiments of the disclosure may be set forth or may be apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF DRAWINGS

A full and enabling disclosure, including the best mode thereof, directed to one of ordinary skill in the art, is set forth more particularly in the remainder of the specification, which makes reference to the following figures.

FIG. 1 schematically represents an electrospinning apparatus used in accordance with the present disclosure.

FIG. 2 is an isolated illustration of the fluid delivery end of a slotted die having a straight spinning edge and orthogonal corners.

FIGS. 3a-3f are illustrations of a representative segment of a first embodiment of a slot die in accordance with the disclosure.

FIGS. 3g-3l are illustrations of an enclosed slot die according to FIG. 3a.

FIGS. 4a-4g are illustrations of a representative segment of a second embodiment of a slot die in accordance with the disclosure.

FIGS. 4h-4m are illustrations of an enclosed slot die according to FIG. 4a.

FIGS. 5a-5f are illustrations of a representative segment of a third embodiment of a slot die in accordance with the disclosure.

FIGS. 5g-5l are illustrations of an enclosed slot die according to FIG. 5a.

FIG. 6 is an illustration of electrospinning fibers emanating from the first embodiment illustrated in FIG. 3j.

FIG. 7 is an illustration of electrospinning fibers emanating from the third embodiment illustrated in FIG. 5j.

FIGS. 8a-8d are illustrations of a representative segment of a fourth embodiment of a slot die in accordance with the disclosure.

### DETAILED DESCRIPTION OF INVENTION

The present disclosure will now be described more fully hereinafter with reference to the accompanying figures, in which some, but not all embodiments of the disclosure are shown. Similar or identical features of the embodiments are provided with like reference numbers. Indeed, the disclosure may be embodied in many different forms and should not be construed as limited to the embodiments set forth herein; rather, these embodiments are provided so that this disclosure will satisfy applicable legal requirements. Each example is provided by way of explanation of the disclosure, and is not intended to be limiting of the disclosure. In fact, it will be apparent to those skilled in the art that various modifications and variations can be made in the present disclosure without departing from the scope or spirit of the disclosure. For instance, features illustrated or described as part of one embodiment can be used in the context of another embodiment to yield a further embodiment. Thus, it is intended that the present disclosure covers modifications and variations that come within the scope of the disclosed embodiments and their equivalents.

The present disclosure is directed to an apparatus 11 and process for electrospinning polymeric preparation 9 (i.e., polymeric solution, dispersion, suspension, or melt) into fibers for the formation of non-woven sheets, membranes, tubes, and coatings with the potential for multiple other applications and forms. In particular, the present disclosure is directed to high throughput electrospinning of nanofibers formed from spinning a polymeric preparation 9 from a slot die 10 so shaped and configured as to result in a substantially uniform electric field formed along the spinning edge 12 when high voltage is applied across the slot die 10 or polymeric preparation 9 and collector 15 of the electrospinning apparatus 11.

One aspect of the disclosure provides for an even distribution of polymeric preparation 9 to the edge of a slit 16. Jet stability can be controlled by slit edge shape, gap width, applied voltage, or a combination of these parameters. Jet stability can be controlled and adjusted accordingly to produce espun sheets with different physical and mechanical properties. When a sufficiently strong electric field is formed when voltage is applied to the slot die and the sharpness of the die sharp edge 34 is sufficiently sharp to provide suitable perturbation, Taylor cones are formed and electrospinning jets 14 of the polymeric preparation 9 erupt from the slit 16 in the slot die 10. The jets 14 travel from the slit 16 of the slot die 10 toward a grounded or oppositely charged collector 15 to form a solid nonwoven material. In one embodiment, the disclosure focuses on slot dies in general and, in particular, the impact of the slot die's shape on the electric field uniformity to optimize electrospinning output.

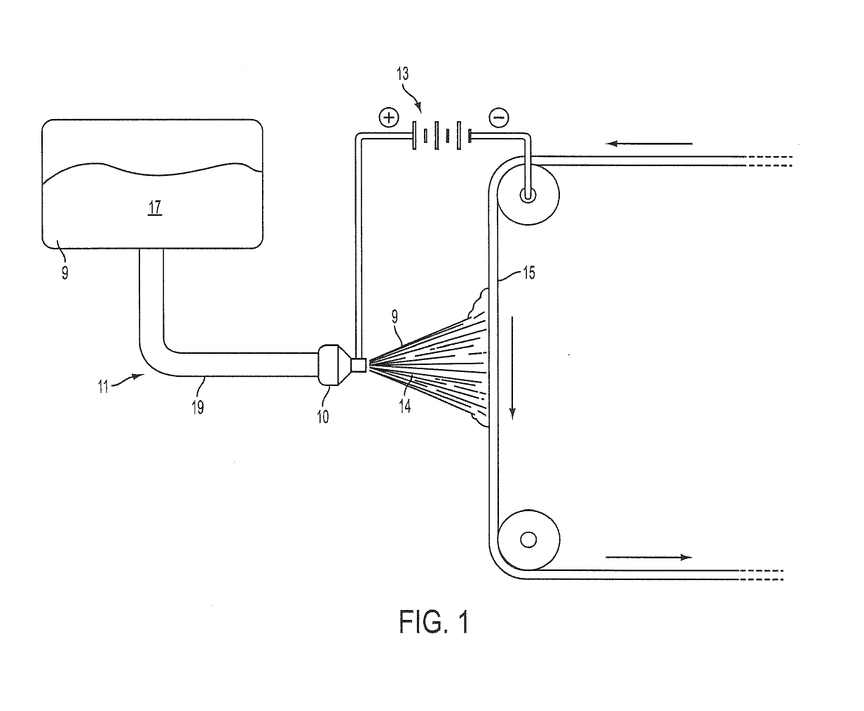

An electrospinning apparatus 11 is illustrated schematically in FIG. 1. In FIG. 1, a reservoir 17 can be loaded with a polymeric preparation 9. A delivery mechanism or pathway network 19 delivers the polymeric preparation 9 from the reservoir to a slot die 10. A power source 13, such as a DC power supply may be used to supply power to the slot die 10 if the slot die is made of conductive material and/or directly to the polymeric preparation 9 if the slot die is made of nonconductive material. The power source 13 establishes a voltage difference of 10 to 300 kV between the slot die 10 and the collector 15 and maintains a certain voltage difference between 30 and 150 kV. In one embodiment, the electrospinning apparatus 11 may comprise a positive electrode from a high voltage power supply connected to the slot die 10, while a collector 15 can be grounded (or oppositely charged) such that an electric potential is created between the slot die 10 and the collector 15 that are a given distance apart. The charge induced by the connection of the power supply repels the charged polymeric preparation 9 away from the charge source (slot die 10/polymeric preparation 9) and attracts fibers of the polymeric preparation 9 to the collection surface of the collector 15. In another embodiment, the collector 15 can be charged while the slot die 10 is grounded or oppositely charged. In yet another embodiment, the slot die 10 and/or the collector 15 may be negatively charged. In yet another embodiment, the collector 15 can be two points or planes that are separated and either grounded or oppositely charged from the slot die 10. In an alternate embodiment, the polymeric preparation 9 (i.e., solution, dispersion, suspension, or melt) can be charged and the collector 15 is grounded or oppositely charged.

The polymeric preparation (i.e., solution, dispersion, suspension, and/or melt) used to produce fibers can have a viscosity of between 1 and 200,000 cP. This polymeric preparation can be pumped through a pathway network 19 such as a tube, hose, vessel or the like and provided to the slot die 10 and thus the spinning edge 12 at a rate of between 0.1 and 5000 milliliters per hour per centimeter length of slit, or at a rate of 10 and 500 milliliters per hour per centimeter length of slit. In one embodiment, the polymeric preparation 9 can be supplied to the spinning edge 12 in a uniform manner across the slit length pneumatically, hydraulically, mechanically, or by gravity. In order to encourage uniform fiber spinning in accordance with at least one embodiment of this disclosure, it is important to provide a uniform distribution of polymeric preparation 9 across the die spinning edge 12, which will be discussed in more detail below.

Materials to be electrospun into fibers according to the methods disclosed herein include dextran, alginates, chitosan, polyvinylpyridine compounds, cellulosic compounds, cellulose ether, hydrolyzed polyacrylamides, polyacrylates, polycarboxylates, polyethylene oxide, polyethylene glycol, polyethylene imine, polyvinylpyrrolidone, polyacrylic acid, poly(methacrylic acid), poly(vinyl alcohol), poly(vinyl alcohol) 12% acetyl, hydroxylpropyl cellulose, cellulose acetate, cellulose nitrate, alginic ammonium salts, pullulan, xanthan gum, polyurethanes (DSM (Bionate, Carbosil, Pursil), Lubrizol® (TG-500, SP-93A-100, tecophilic product line), AdvanSource® (C55D, C80A, and Hydrothane)), polystyrene, polymethacrylates, Teflon®, polyvinylidene fluoride, perfluoroalkoxy, fluorinated ethylene propylene, polytetrafluoroethylene, polyacrylonitrile, nylons, PEBAX®, polycarbonates, polyethylene terephthalate, polyesters, polyamides, poly(amic acid), polyimide, polylactic acid, polyglycolic acids, blends or copolymers of polylactic acid and polycglycolic acid, polyvinyl chloride, polycaprolactone, polyaniline, and blends and copolymers thereof.

The above solutions and dispersions of polymers may be combined with various additives and modifiers such as silver, calcium carbonate, hyaluronic acid and the like to produce beneficial modifications and features in the electrospun fibers.

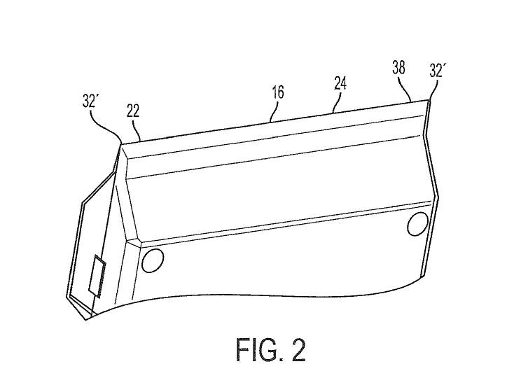

FIG. 2 illustrates a comparative example of an electrospinning slot die 22 with a flat spinning edge 24. The flat spinning edge 24 has no radius of curvature. The flat slot die 22 has a slit 16 at the discharge end 38 of the slot die 22. The corners 32′ of the slot die 22 generally define orthogonal or right angles. When an electric potential is applied to the slot die 22 or polymeric preparation 9, an electric field is generated and intensifies generally at the corners 32′. The intensified electric field at the orthogonal corners creates a repulsive force and decreases the stability of the electrospinning jets 14 nearby (leading to a possible increase in fiber breakage, a lessening of uniform fiber disposition, and a widening range of fiber diameters).

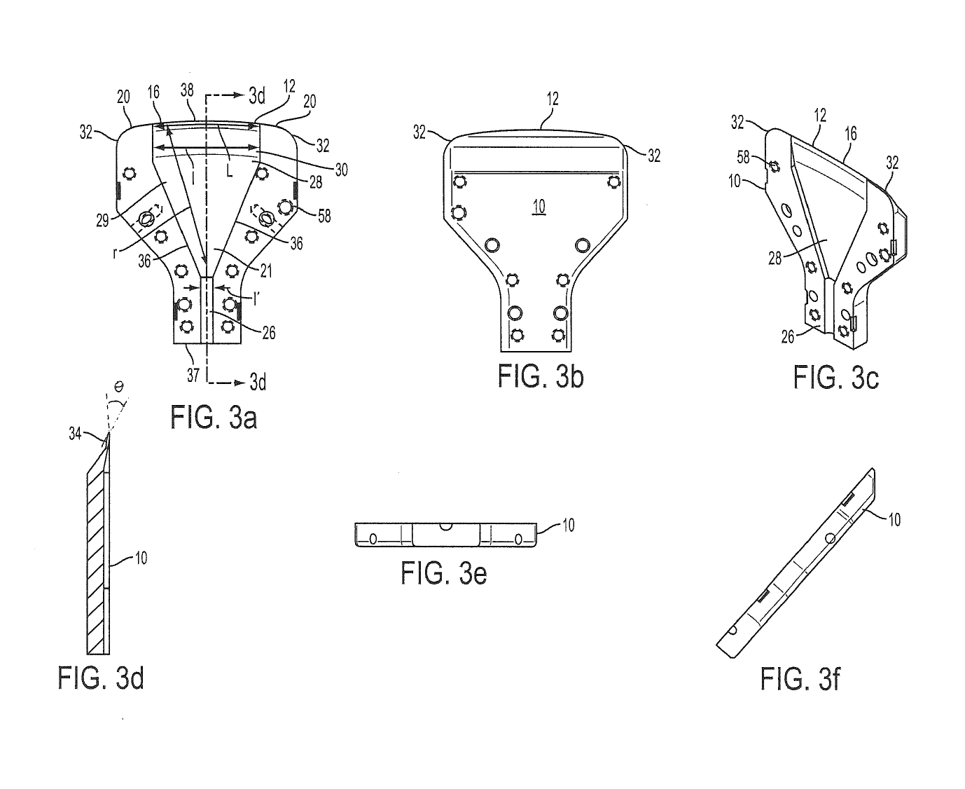

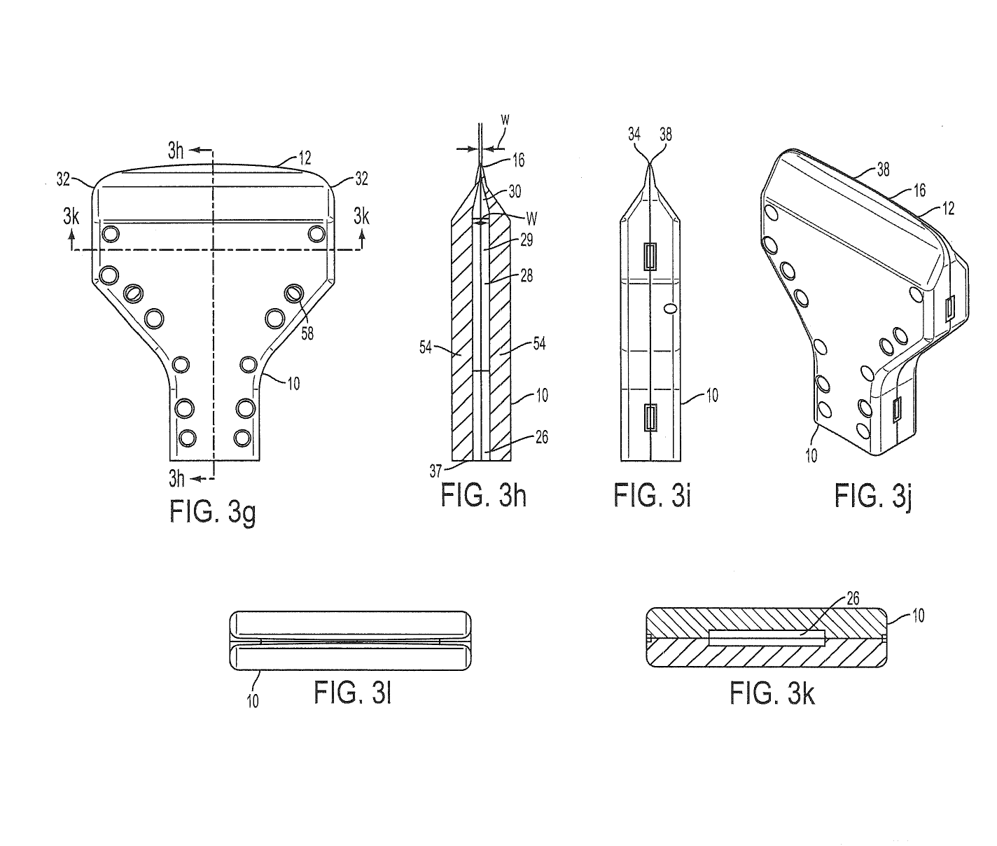

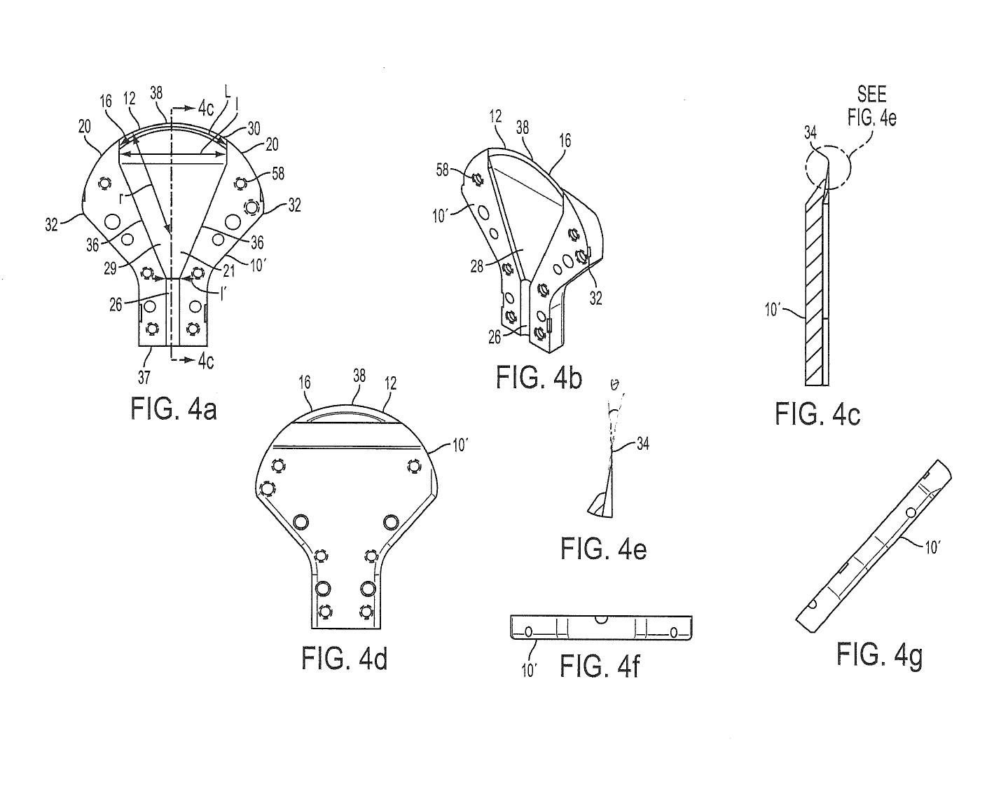

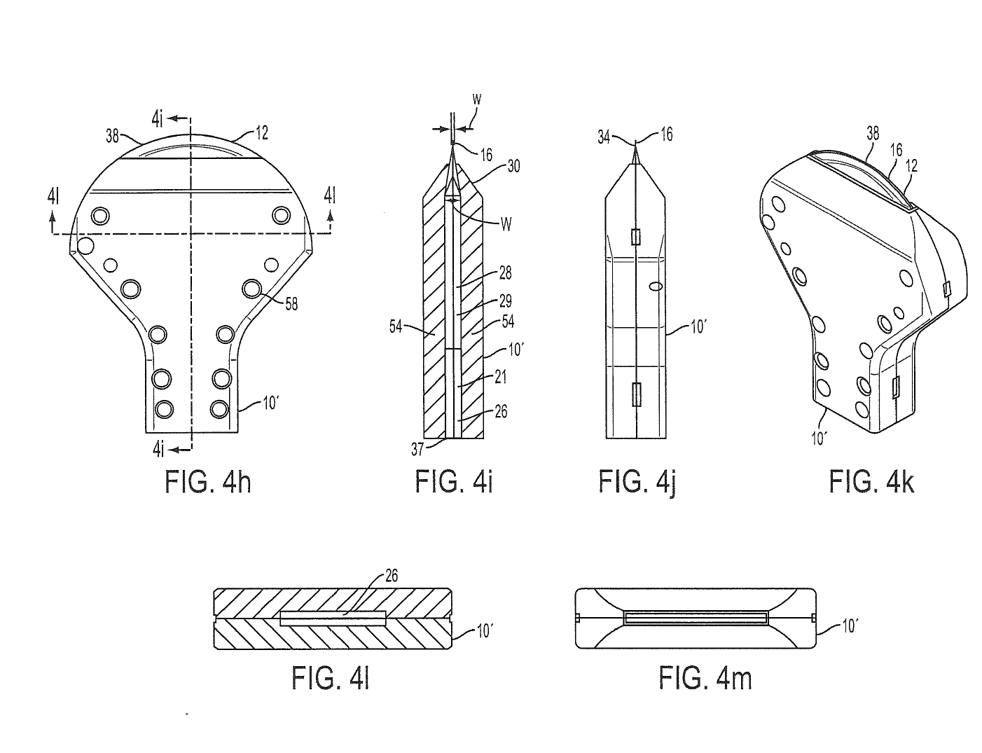

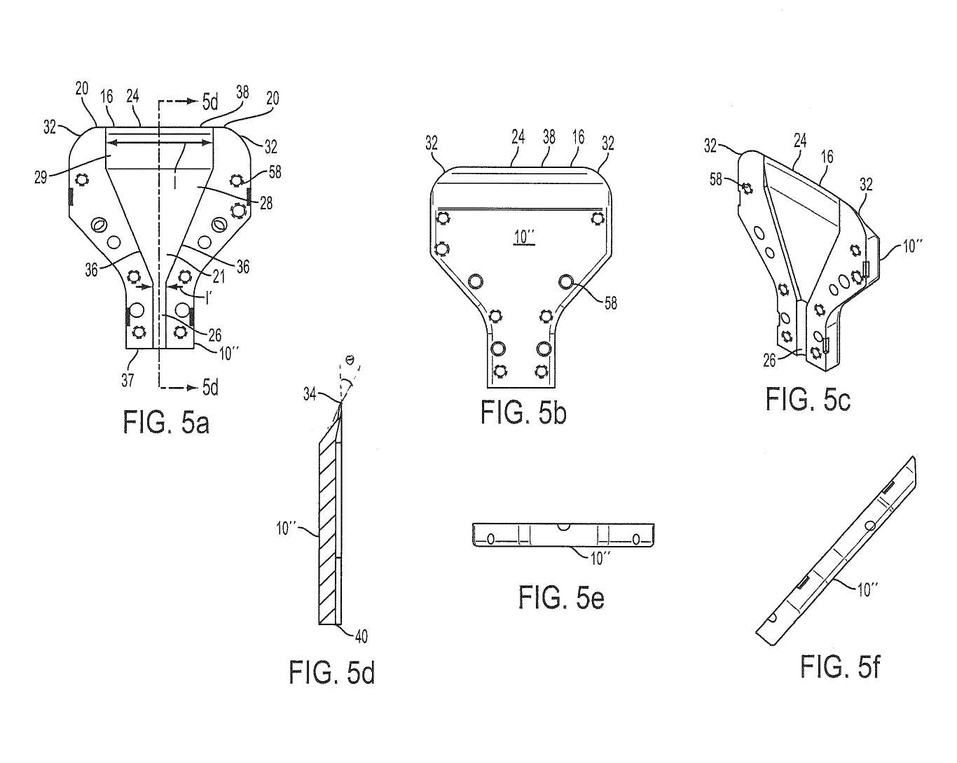

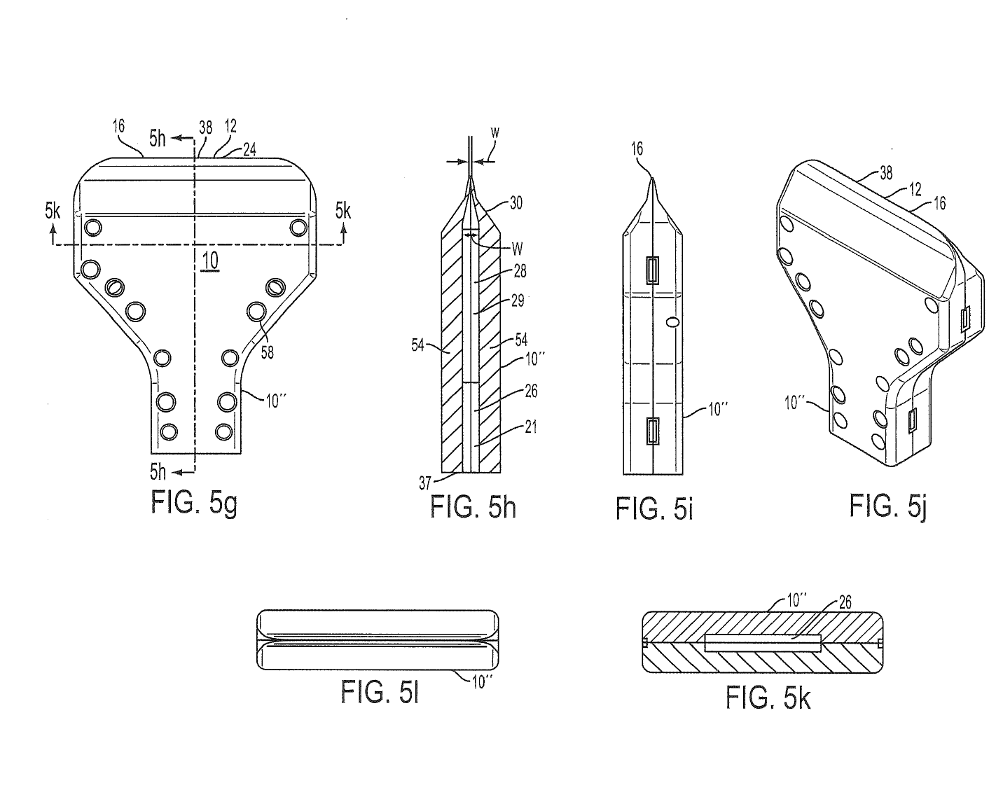

As illustrated in FIGS. 3a-3j, the slot die 10 of the present disclosure departs from traditional slot dies by inter alia departing from traditional straight (flat) edge 24 and straight/orthogonal (e.g. approximately 90°) corners 32′. Such traditional “straight” or orthogonal features are depicted in FIG. 2. According to the present disclosure, the slot die 10 can be defined with substantially curved, including multiple radii curve or single radius arc, edges and/or curved, including multiple radii or single radius arc, corners at or about the discharge end 38 of the die. Some example embodiments depicting alternate edge designs (see FIGS. 4a-5l) are discussed herein.

In one embodiment, the slot dies 10 (10, 10′, 10″) may be comprised of a conducting material such as gold, brass, copper, silver, steel, platinum or other metal and alloys thereof. In other embodiments, the slot dies 10 (10, 10′, 10″) could be totally or partially comprised of non-metal or non-conducting materials such as plastics, ceramics, etc. As illustrated in FIGS. 3h, 4i, and 5h, the slit width (“w”) or distance between the edges 34 of the slit 16 should be of sufficient width to allow for Taylor cone formation and stabilization, in general, and be between 0.01 mm and 10 mm, inclusive, or between 0.05 mm and 1 mm, inclusive. In one embodiment, as illustrated in FIGS. 3a and 4a, the arc length (“L”) or the length of the edge 34 of the slit 16 can be between 1 cm and 10 m, inclusive, or in one embodiment, between 5 cm and 1 m, inclusive.

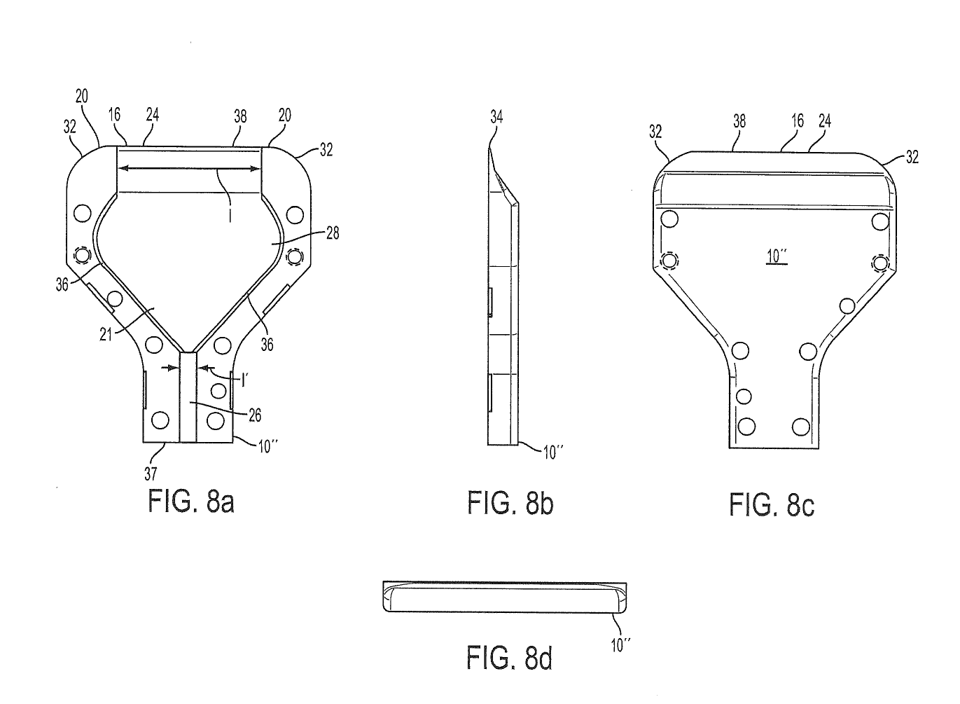

FIGS. 3a-4m illustrate electrospinning slot dies 10 (10, 10′) unique to the present disclosure with a spinning edge 12 having a radius of curvature “r”. The spinning edge 12 may have a sharp edge 34 as shown in FIGS. 3d, 4e and 5d. An angle (θ) defined by the sharp edge 34 provides suitable perturbation for Taylor cone formation. The angle (θ) of the sharp edge 34 may range from 1 degree to 90 degrees inclusive, or 1 degree to 45 degrees, inclusive. Each of the slot dies 10 (10, 10′, 10″) has a fluid pathway network 21 that includes a flow channel 26 at the fluid entry end 37, a cavity 28, and a spinning edge 12 with a slit 16 at the discharge end 38 of the slot die. The cavity 28 (also, the entire fluid pathway network 21) may have a different shape depending on the polymeric preparation 9 used. For example, the cavity 28 may comprise straight walls 36, as shown in FIGS. 3a, 4a, and 5a, for creating a uniform flow and distribution. However, walls 36 may have curved, including without limitation arcuate, portions (see FIG. 8a) and the angle between the walls 36 may vary depending on the polymeric material 9 used without departing from the disclosure.

In one embodiment, the cavity 28 may comprise a divergent section 29 and convergent section 30. The divergent section 29 expands from a smaller length (l′) beginning at the end of the flow channel 26 to a larger length (l), the cord length of the slit. The convergent section 30 narrows from a larger width (W) to a smaller slit width (w). The purpose of the fluid pathway network 21 of the present disclosure can be to provide the polymeric preparation 9 to the die slit with as much uniformity as possible along the length (L) of the slit, and a variety of other (non-depicted) pathway networks may be utilized as will be understood by those skilled in the art.

According to one embodiment of the present disclosure, as depicted by FIGS. 3a-3f, the slot die 10 has a spinning edge 12 that can be curved along its length (L), the spinning edge thus defining at least one arc having a radius of curvature (r). In accordance with certain aspects of the present disclosure, the radius of the spinning edge 12 and size, sharpness, and shape of the slot die 10 affects the electrical field shape and the flow of the spinning material. The radius “r” can be optimized (as discussed below) to increase the yield and uniformity of both the fibers and the nonwoven material produced over a slot die 22 of traditional “straight” features.

One goal of the design of the slot die, in accordance with at least one embodiment of the present disclosure is to create, as much as possible, a uniform electric field along the spinning edge 12. According to some embodiments of the present disclosure (see, e.g., FIGS. 3a-4m), to foster a uniform electric field, the spinning edge has a curvature (radius) along the arc length (“L”) of the spinning edge 12. According to one exemplary embodiment, the curved spinning edge 12 defines a single arc having a radius of curvature “r” of 1 cm to 1 meter, or a radius of curvature “r” of 5 cm to 100 cm. The radius of curvature of the spinning edge 12 induces a substantially more uniform electrical field compared to the flat slot die 22 where the electric field intensifies at the corners 32′, repelling the jets 14 and causing jet instability. Thus, the slot die 10 with a curved spinning edge 12 can be capable of producing a higher throughput and a higher useable mat width than can be produced by the flat slot die 22 with a flat spinning edge 24. The useable mat width is the width of the mat that is generally parallel to the length of the spinning edge and is defined as 20% or less variation of the mat thickness or mat depth (i.e., generally perpendicular to the mat width) measured from the center of the mat. When comparing a flat or non-radius slot die 22 with orthogonal corners to a slot die 10, 10′ having an arcuate spinning edge 12 and the arcuate spinning edge having a radius of curvature defined in the aforementioned range, the useable width of the resultant non-woven mat product generated by the slot die having a curved spinning edge may be increased by 10 to 1000%, or by 25 to 250%.

In one embodiment, a die with multiple slits and/or multiple single slit slot dies either in series or in parallel may be used without departing from the disclosure.

Other properties of the non-woven mat can be controlled, altered, or improved in accordance with this disclosure. These include but are not limited to: fiber diameter, porosity, fiber uniformity, total spinning width, fiber quality, fiber orientation, air flow, air permeability, cellular ingrowth, cellular attachment, surface area, tensile strength, max load, elasticity, opacity, pore size, and bubble point. Various such properties of interest in a non-woven mat are described, for example, in U.S. Pat. No. 8,262,979 and U.S. Pat. Publication Nos. 2013/0268062 A1, 2013/0053948 A1, and 2013/0197664 A1, which are incorporated herein by reference in their entireties.

FIGS. 4a-4g illustrate a slot die 10′ that has a spinning edge 12 with a smaller radius of curvature compared to the slot die 10 of FIG. 3a. In another embodiment, the corners 32 (see FIGS. 4a, 5a, and 8a) can be generally curved, including rounded (i.e., arcuate), having a radius of sufficient curvature to foster a substantially uniform electrical field and, in general, can be between 1 mm and 1 m, inclusive, or between 1 mm and 100 mm, inclusive. The rounded corners 32 further distribute the induced electrical field, reducing the build-up and effect of the electrical field on the electrospinning jets 14 at the corners 32 compared to slot die 22 with a flat spinning edge 24 and corners 32′ generally defining right angles. The rounded corners 32 may be adjacent the spinning edge and extend outwardly therefrom. In one example, the rounded corner may be proximate the spinning edge and in another embodiment the slot die may have a shoulder section 20 between the spinning edge and the rounded corners.

In some embodiments, the slot dies 10 (10, 10′, 10″) may comprise shoulder sections 20 that extend between and connect the edges of the slit 16 and the curved corners 32. The shoulder sections 20 may be curved or straight and may range in length from 1 mm to 10 m, inclusive, from 1 cm to 1 m, inclusive, or in one embodiment, from 1 cm to 30 cm, inclusive. In accordance with alternative embodiments of the disclosure, the shoulder sections 20 can be otherwise shaped, positioned, arranged, and/or omitted without departing from the disclosure.

In some embodiments of the disclosure, the curved spinning edge 12, the shoulder sections 20, and curved corners 32 affect Taylor cone stability. Different spinning edge 12, shoulder section 20 and corner 32 geometries can, according to the present disclosure, effect varying degrees of non-uniformity (and uniformity) of the electric field, thus affecting the Taylor cone stability differently. When a jet 14 is formed and spinning from a slot die 22 (FIG. 2) with a flat spinning edge 24 and orthogonal corners 32′, there can be an instability that forms due to the non-uniformity of the electric field when a high voltage (e.g., a voltage above 80 kV) is applied to the slot die or polymeric preparation 9. The instability from the non-uniform electric field causes the Taylor cones to “walk” or move across the die slit 16. This movement of a jet 14 can cause the termination of the jet 14 once it reaches the end of the slit length. A new jet may form to replace the recently terminated jet; however, jet termination and reformation can cause fiber defects and breakage. In accordance with one embodiment of the present disclosure, the Taylor cones or jets are stabilized from moving by making the electric field more uniform across the arc length (“L”) of the slot die slit 16, thus increasing the jet life and reducing the amount of defects and fiber breakage (e.g., by 10-1000% depending upon the characteristics of the electrospinning polymeric preparation 9 and uniformity of the electric field). Both the curved spinning edge 12 and curved corners 32 foster a uniform (or in some embodiments varying degrees of non-uniform) electric field by preventing or reducing the electric field from intensifying at orthogonal corners. Further, stability of the Taylor cones or jets also narrows fiber size distribution and increases non-woven mat uniformity. In addition to improved jet stability, the number of jets 14 increases with the decrease of the radius of curvature of the spinning edge. Decreasing the radius of curvature of the spinning edge increases the number of jets by 1 to 200% that will form in the same slit length. The increased number of jets can improve throughput by 5-200%.

In one embodiment, the slot dies 10 (10, 10′, 10″) may comprise two half portions 54 with identical features illustrated in FIGS. 3a-5l. The two half portions 54 may be held together by adhesive or mechanical fastening means 58 such as screws, bolts, or similar means as illustrated in FIGS. 3j, 4k, and 5j. Alternatively, one half of the slot die could comprise fluid flowing features (i.e. flow channel, cavity, etc.) and the other half of the slot die may be a die cover plate (not shown) for closing the slot die. The die cover plate may or may not comprise fluid flowing features.

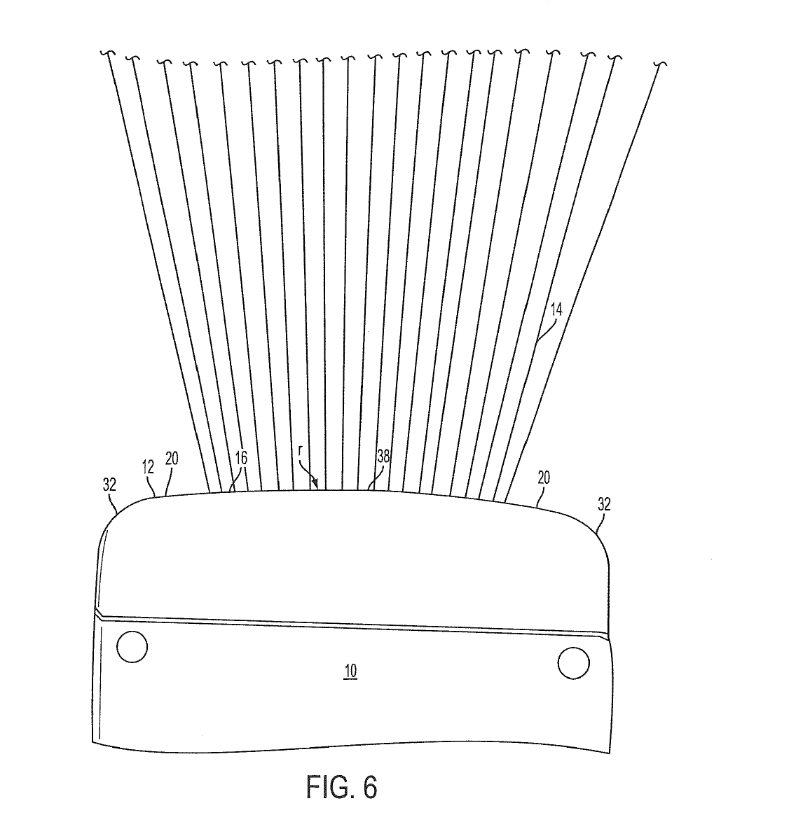

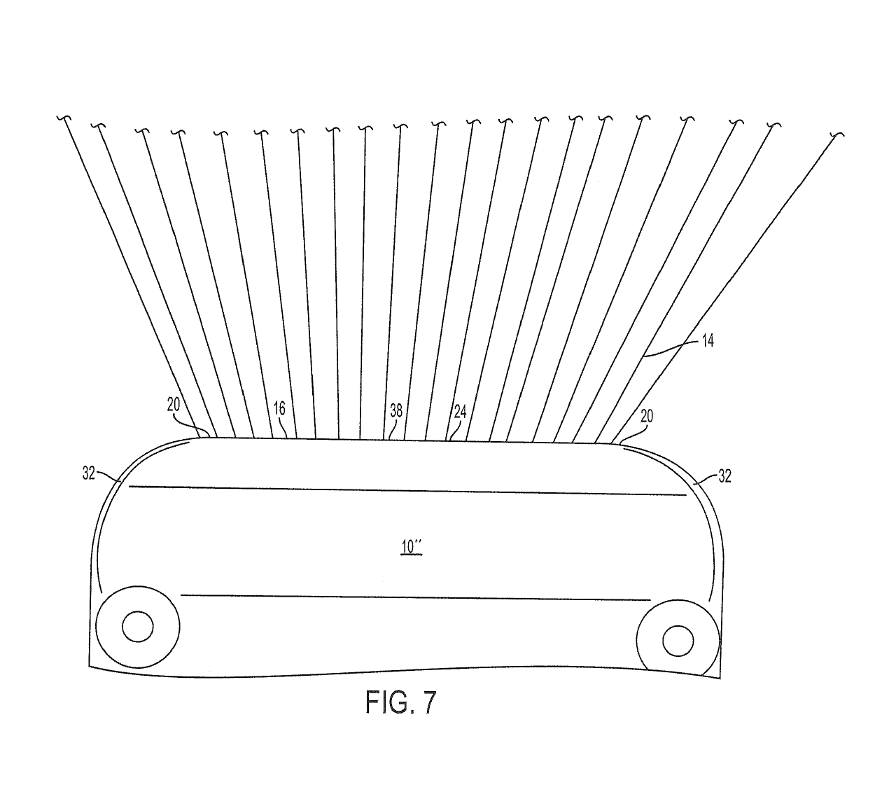

FIGS. 6-7 are illustrations of the discharge of the jets 14 during the process of electrospinning, wherein an electric field is applied across the polymeric preparation 9 causing jets 14 to erupt from the slot dies 10 and 10″. The jet number is affected by the type of polymeric preparation 9 used, the voltage, the collector height and viscosity of the polymeric preparation 9. FIG. 6 illustrates a slot die 10 with an arcuate spinning edge 12 and rounded corners 32, and FIG. 7 illustrates a slot die 10″ with a flat spinning edge 24 and rounded corners 32. Further, as the radius of curvature “r” of the spinning edge 12 of the slot die decreases, the fiber defects decrease and fiber uniformity increases.

Table 1 below illustrates how certain properties can be affected in accordance with at least one embodiment of the present disclosure.

TABLE 1
Fiber and fabric properties obtainable according to
certain embodiments

| Property (unit of measure) | Range |
|---|---|
| Average fiber diameter (nm) | 50-20,000 |
| Porosity (%) | 20-95 |
| Mean pore size (um) | 0.1-10 |
| Bubble point (um) | 0.1-20 |
| Fiber uniformity around average (%) | ±10-50% |
| Total spinning width increase (%) | 5-1000 |
| Air permeability (cfm) | 1-100 |
| Surface area (m\hat{ }2/g) | 0.5-2000 |
| Tensile strength (psi) | 100-10000 |
| Max load (lbf) | 0.01-20 |
| Throughput (%) | 5-200 |

### EXAMPLE 1

Polyurethane (PU) was electrospun using a flat slot die design similar to slot die 22 as illustrated in FIG. 2. A solution containing 7.5 wt % of TG-500 (Lubrizol) in acetic acid was pumped using a syringe, to a flat (non-radius) slot spinning die, having a slit length of 1.187″ and a slit width of 0.008″ at a rate of 90 ml/hr. The voltage applied was 95 kV and the distance between the slot die and the collector 15 was 12 inches. The nonwoven mat produced had a useable mat width of 3 inches with an average fiber diameter of 0.824 um.

### EXAMPLE 2

Polyurethane (PU) was electrospun using the radius slot die 10 as illustrated in FIG. 3j, in accordance with the present disclosure. A solution containing 7.5 wt % of TG-500 (Lubrizol) in acetic acid was pumped at a rate of 90 ml/hr using a syringe to a radius slot die having a spinning edge with a 5.5 inch radius of curvature, a slit length of 1.187″ and a slit width of 0.006″. The voltage applied was 95 kV and the distance between the slot die 10 and the collector 15 was 12 inches. The nonwoven mat produced had a useable mat width of 4 inches with an average fiber diameter of 0.865 um. This demonstrates a 1 inch or 25% increase in useable width under the same spinning conditions as compared to the flat slot die of Example 1.

### EXAMPLE 3

PU was electrospun using a die design incorporating a flat edge (with a spinning edge having no radius of curvature) and rounded/curved corners as shown in FIGS. 5j and 8a. A solution containing 9 wt % TG-500 in acetic acid was electrospun at a height of 12″, a voltage of 97 kV, and a flow rate of 90 mL/hr from both dies. The two dies differed in the slot gap (i.e. slit) width with Sample 3.1 being produced from the die 10″ shown in FIG. 8a with a 0.012″ gap width while Sample 3.2 was produced from the die shown in FIG. 5j with a 0.007″ gap width.

There were two noticeable differences between the two sheets produced by the dies with different gap widths. The 0.012″ gap die produced an espun PU sheet with 0.4 inches more usable width. However, this was also accompanied by significantly more surface defects. These types of surface defects are usually attributed to jet instability. It appears the larger gap width is responsible for both of these differences. The larger gap would allow for larger jets and/or more jets, depending upon the voltage which was set high for this example. The increased mat width is believed to be due to the greater number of jets and the increased number of jets would also lead to greater repulsion between the jets, and thus may lead to “walking” of the jets wherein the jets move along the spinning edge. This action causes entanglement between the jets as well as broken fibers that can both lead to surface defects. Controlling the spinning parameters in conjunction with the gap width can allow for various sheet widths and densities to be produced.

While in certain aspects of the current disclosure, the goal is to maximize the stability and control of the Taylor cones or jets in order to achieve more uniform fibers and electrospun fabric, certain embodiments of the present disclosure are for the control and utilization of induced instability for the purposes of creating fibers with lower aspect ratios or lengths, more broken fibers and surface defects on the electrospun fabric, as understood from the previous description, by manipulating various aspects of the slot die (e.g., the slit width, the curvature of the spinning edge and/or the corners) in accordance with principles described above. The ability to control the stability of the electric field and subsequently the stability of the Taylor cones or jets formed at the face of the slot die is key in controlling the uniformity of the fibers and resulting electrospun fabric. While most potential applications benefit from increased uniformity, there are certain applications where induced defects and differences in uniformity are important.

The foregoing description generally illustrates and describes various embodiments of the present disclosure. Regarding the values provided in the above discussions, those values may be approximate, such as in other embodiments that are like the above-disused embodiments. It will, however, be understood by those skilled in the art that various changes and modifications can be made to the above-discussed construction of the present disclosure without departing from the spirit and scope of the disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present disclosure as set forth in the appended claims.

1. A process for high throughput of electrospun fibers, the process comprising:
providing a polymeric preparation to a slot die of an apparatus, wherein the slot die has a spinning edge with a slit and at least one corner adjacent the spinning edge, and the polymeric preparation comprises material selected from the group consisting of a polymeric solution, polymeric dispersion, polymeric suspension, polymeric melt and any combination thereof;
applying voltage to at least a portion of at least one of the apparatus and the polymeric preparation;
generating with the slot die an electric field across the spinning edge; and
producing a plurality of Taylor cones with jets to stretch the polymeric preparation into a fibrous structure.

2. The process of claim 1, wherein the spinning edge is curved.

3. The process of claim 2, wherein the spinning edge has a radius of curvature of at least 1 cm.

4. The process of claim 3, wherein the spinning edge has a radius of curvature between 5 and 100 cm inclusive.

5. The process of claim 2, wherein the at least one corner is a rounded.

6. The process of claim 1, wherein the spinning edge is flat and the at least one corner comprises a first corner and a second corner, the first corner and second corner are rounded.

7. The process of claim 1, wherein the apparatus comprises a power source to apply a voltage difference between the slot die and a collector and the voltage difference is between 10 to 300 kV.

8. The process of claim 4, wherein the fibrous structure comprises a stretched fiber with a diameter of less than 10 microns.

9. The process of claim 4, wherein the apparatus includes a collecting area having at least one electrically grounded point thereon, the process further comprising the step of collecting the fibrous structure within the collecting area.

10. The process of claim 5, wherein the electric field is substantially uniform across the spinning edge.

11. The process of claim 1, wherein the slot die is shaped to control the stability or instability of the electric field.

12. An apparatus for high throughput of electrospun fibers, the apparatus comprising:
a slot die having a spinning edge with a slit and at least one corner adjacent the spinning edge, the slot die being shaped to control an electrical field along the slit and spinning edge when voltage is applied to the slot die;
a collector installed a distance away from the slot die;
a power source to apply a voltage difference between the slot die and the collector; and
a pathway to supply a polymeric preparation to the slot die.

13. The apparatus of claim 12, wherein the slot die further comprises a flow channel and a cavity.

14. The apparatus of claim 12, wherein the spinning edge defines at least one arc along the length of the slit.

15. The apparatus of claim 14, wherein the at least one arc has a radius of curvature of at least 1 cm.

16. The apparatus of claim 14, wherein the at least one arc has a radius of curvature between 5 and 100 cm inclusive.

17. The apparatus of claim 14, wherein the at least one corner comprises a first corner and a second corner adjacent the spinning edge, and the first corner and second corner are rounded.

18. The apparatus of claim 12, wherein the spinning edge is flat and the at least one corner comprises a first corner and a second corner adjacent the spinning edge, and the first corner and second corner are rounded.

19. The apparatus of claim 12, wherein and the slot die comprises rounded corners at the edges of the spinning edge.

20. The apparatus of claim 12, wherein the slot die is shaped to generate a substantially uniform electric field.

21. The apparatus of claim 12, wherein the slot die is shaped to control a non-uniform electric field.

22. A slot die for use in electrospinning fibers, the slot die comprising
a spinning edge with a slit,
at least one corner adjacent the spinning edge, and
a fluid pathway network for providing a polymeric preparation to the slit; and
wherein at least one of the spinning edge and the at least one corner defines a curve.

23. The slot die of claim 22, wherein the at least one corner is a rounded corner.

24. The slot die of claim 22, wherein the spinning edge defines a curve.

25. The slot die of claim 23, wherein the spinning edge is flat.

26. The slot die of claim 23, wherein the spinning edge defines a curve and the at least one corner defines a curve.
